(19) United States
(12) Patent Application Publication
(10) Pub. No.: US 2015/0023736 A1
(43) Pub. Date: Jan. 22, 2015

(54) WEIGHT TRANSFER SYSTEM FOR PITCH PLOWS

(71) Applicants: Jason Gierman, Marlette, MI (US); Joseph Gierman, Decker, MI (US)

(72) Inventors: Jason Gierman, Marlette, MI (US); Joseph Gierman, Decker, MI (US)

(21) Appl. No.: 13/943,243

(22) Filed: Jul. 16, 2013

(51) Int. Cl. F16L 1/028

(52) U.S. Cl. CPC F16L 1/028
USPC 405/154.1

(57) ABSTRACT

A weight transfer system for pitch plows that allows the pitch plows to draw underground at an accurate depth without inadvertent depth changes in the operation of the plow. The dynamic weight transfer system exerts upward or downward force on the plow to optimize plow operation. The reaction force of the dynamic weight transfer system is applied to the towing mechanism. The amount of force and direction can be adjusted to optimize the plowing operation as plowing conditions change.

### BACKGROUND OF THE INVENTION

This invention deals with a weight transfer system for pitch plows that allows the pitch plows to draw underground at a desired depth without constant depth changes in the operation of the plow.

A pitch plow is a device that is used for laying items underground such as flexible pipe and electrical cable. The pitch plow is towed across the ground with a towing mechanism such as a tractor or bulldozer. The material being laid into the ground is fed into a boot which is attached to the shank of the pitch plow. The material travels down the boot, exiting below ground level at the elevation established by the cutting edge of the plow. The grade or depth of prior art plows is controlled by pitching the shank/cutting edge with a pitch control mechanism.

Prior art pitch plows have some inherent negative properties. Prior art pitch plows operate at a higher positive pitch. The positive pitch is required as this provides upward force to counter the weight of the plow. This type of plow has issues, such as accelerated wear on the bottom wear shoe of the shank; increased friction between the plow and the soil causing it to be more difficult to pull through the ground; increased soil compaction under the plow where the material rests; the plow will not hold grade in deep soft soils such as muck and deep top soil conditions, and, increased probability of damaged material from operating at high positive pitch.

Such devices can be found for example, in U.S. Pat. No. 4,397,585, that issued to Fouss, et al on Aug. 9, 1983 which deals with a method of install drainage tile that is purchased and arrives at the installation site in a folded form instead of being circular. This patent focuses on how the machine takes folded tile and unfolds it as it installs it into the ground.

A second references is U.S. Pat. No. 4,430,022, that issued to Finnan on Feb. 7, 1984 deals with unique positioning of the cable installed equipment, in that, this device can be pulled behind, to the side or pushed ahead of the towing equipment.

Another reference is U.S. Pat. No. 4,477,696, that issued to Vidler on May 17, 1988 that deals with a device that feeds cable to the mechanism that is putting it under the ground. The novelty of the device seems to be that the cable can be fed stress free.

U.S. Pat. No. 4,867,607, that issued to Johnson et al on Sep. 19, 1989 deals with an apparatus for preventing the vibration of a vibrating plow so that it cannot be transmitted to the towing mechanism.

U.S. Pat. No. 6,189,244, that issued to Johnson, et al, on Feb. 20, 2001 deals with a known type of machine that has been improved. The improvement appears to be a cleaning system to keep heavy clay soil from sticking to the mechanism.

U.S. Pat. No. 6,244,355, that issued to Hall on Jun. 12, 2001 deals with an anti-vibration device as that found in U.S. Pat. No. 4,867,607.

U.S. Pat. No. 6,397,500, that issued to Hall on Jun. 4, 2002 deals with a plow that has a leading edge that oscillates, thus reducing the amount of force it takes to pull the plow through the ground.

U.S. Pat. No. 8,090,507, that issued to Yegerlehner on Jan. 3, 2012 deals with the use of GPS to control depth.

U.S. Pat. No. 8,157,477 that issued to Horan et al, on Apr. 17, 2012 utilizes a circular trenching blade rather than a pitch plow.

U.S. Pat. No. 8,352,131, that issued to Yegerlehner, et al on Jan. 8, 2013 deals with using a GPS instead of a laser to control the installation depth of drainage tile.

### SUMMARY OF THE INVENTION

The device of the instant invention differs from that set forth in the references described supra. The instant invention provides a pitch plow that remedies the problems associated with those set forth in the references and creates an additional benefit. The instant invention uses the weight transfer system to transfer a portion of the weight of the plow from the ground to the towing mechanism while it is being towed through the ground. The elevation of the shank assembly is still controlled by the pitch of the shank. That resulting shank pitch angle is greatly reduced. The additional benefit created by this invention is a result of the weight transfer of the plow to the towing mechanism. This weight transfer increases traction of the towing mechanism which in turn allows for deeper operation of the pitch plow.

### THE INVENTION

In one embodiment, there is a weight transfer system for pitch plows, the weight transfer system comprises a mounting system for the weight transfer system. There is also at least one lifting/lowering mechanism attached to the pitch plow and a hydraulic valve packet that controls oil flow and pressure to the lifting/lowering mechanism.

There are at least two hydraulic hoses connected by one end to a hydraulic oil system and connected at the opposite end to each lifting/lowering mechanism to deliver the oil to and from the lifting/lowering mechanism, and, a means of controlling the hydraulic valves in the hydraulic valve packet.

In a second embodiment, there is in combination, a weight transfer system for pitch plows. The combination comprises a mounting frame connected to a towing vehicle. The mounting frame has mounted on it, a shank assembly, the shank assembly being connected to two, parallel upper link arms and two, parallel lower link arms. The lower link arms have a predetermined length, a distal end and near end. The lower link arms are rotationally attached at the near end to a vertical frame strut and rotationally attached at the distal end to the shank assembly.

The upper link arms have a predetermined adjustable length, provide by length adjusting hydraulic cylinders. The length adjusting hydraulic cylinders have a distal end and a near end. The upper link arms are rotationally attached at the near end to respective length adjusting hydraulic cylinders and rotationally attached at the distal end to the frame 109.

There is a lifting/lowering mechanism having a distal end and a near end, the lifting/lowering mechanism is rigidly attached at the near end to a cross member extending between the parallel lower link arms. The distal end of the lifting/lowering mechanism is rotationally attached at the distal end to a mid-point of the shank assembly. The vertical support strut is attached to the towing vehicle.

The shank assembly comprises a vertical shaft having a lower end, a riser plate attached to the vertical shaft at the lower end, a cutting edge on a leading edge of the riser plate, a wear shoe attached to the lower end and beneath the riser plate and the cutting edge, and, a boot for delivering cable or flexible pipe.

In yet another embodiment, there is a combination as set forth just Supra, wherein the combination has, in addition, hydraulic valves, hydraulic hoses, and controls for the hydraulic valves.

Further, there is in combination, a weight transfer system for pitch plows. The weight transfer system comprises a mounting frame which comprises a horizontal support beam having a near end and a distal end. The mounting frame is rotatably attached at the near end to a vertical shank assembly having a top end and a bottom end and, the distal end is rotatably attached to a vertical shaft near a top end.

There is a pitch adjusting device which comprises a predetermined adjustable length and having a distal end and a near end. The predetermined adjustable device is rotatably attached at the near end to the shank assembly near the top end of the shank assembly. The distal end of the predetermined adjustable device is rotatably attached to the horizontal support beam.

The distal end of the horizontal support beam and the top end of the vertical shaft is connectable to a conventional three-point hitch.

The shank assembly is comprised of a vertical support shaft having a lower end, a riser plate attached to the vertical support shaft, a cutting edge on a leading edge of the riser plate, a wear shoe attached to the lower end and beneath the riser plate and the cutting edge, and a boot for delivering cable or flexible pipe.

Another embodiment is a combination as disclosed just Supra, wherein the combination has, in addition, hydraulic valves, hydraulic hoses, and controls for the hydraulic valves.

Still further, there is an embodiment which is, in combination, weight transfer system for pitch plows. The weight transfer system comprises a mounting frame, wherein the mounting frame comprises two parallel, spaced-apart upper link arms, each upper link arm having a distal end and a near end. There are two parallel, spaced-apart lower link arms, each lower link arm having a distal end and a near end.

There is a pitch adjusting system, a pivoting frame having a bottom end, a shank assembly, wherein the shank assembly comprises a vertical support shank, the vertical support shank having a top end and a bottom end, the bottom end having fixedly attached thereto, a riser plate, the riser plate having a cutting edge on a leading edge of the riser plate; a wear shoe attached to the vertical support shank bottom end and beneath the riser plate and the cutting edge, and attached to the vertical support shank, at the back thereof, and, a boot for delivering cable or flexible pipe;

The distal ends of the upper link arms are rotatably attached near the top of the vertical support shank, and the near ends of the upper link arms are rotatably attached, respectively, to a vertical post of the pivoting frame near the top.

The distal ends of the lower link arms are rotatably attached near the bottom end of the vertical support shank and, the near ends of the lower link arms are rotatably attached to the vertical post of the pivoting frame near the bottom.

There is a hydraulic lift cylinder rotatably attached to a first bar, the first bar is supported between the upper link arms near the distal ends. The opposite ends of the hydraulic lift cylinder are rotatably attached to a second bar, the second bar is supported between the lower link arms, near the near ends.

The pivot frame is rotatably attached near the bottom to a conventional pivoting frame arm plow. There are two parallel, spaced-apart pivoting hydraulic cylinders which are rotatably attached by one end near the top of the, respective, vertical posts of the pivoting frame. The opposite ends of the pivoting hydraulic cylinders are rotatably attached near distal ends to a rigid frame having near ends. Each the near end of the rigid frame is rotatably attached near the bottom of each of the pivoting frame vertical posts, the opposite ends of the rigid frame being connectable to a towing vehicle.

In addition, the combination disclosed just Supra has, in addition, hydraulic valves, hydraulic hoses, and controls for the hydraulic valves.

One final embodiment of this invention is, in combination, a weight transfer system for pitch plows. the weight transfer system comprises a mounting frame. The mounting frame comprises a forward rigid frame assembly having a top end and a bottom end. There are two, parallel, spaced-apart upper link arms each having distal ends and near ends. There are two, parallel, spaced-apart lower link arms each having distal ends an near ends. There are two, parallel, spaced-apart double upper link arms, each having distal ends and near ends and two, parallel, spaced-apart double lower link arms, each having distal ends and near ends.

The distal ends of each respective double upper link arms and the near ends of each respective upper link arms are rotatably commonly connected to each other by a first bar extending between the respective upper link arms and double upper link arms.

The distal ends of each respective double lower link arms and the near ends of the each respective lower link arms are rotatably commonly connected to each other by a second bar extending between the respective lower link arms and lower double link arms.

The upper double link arms are rotatably connected to the near ends to the tops of the vertical support shaft. The lower double link arms are rotatably connected at the near end to the mid-section of the vertical support shaft.

The pitch adjusting system has a near end and a distal end, the near end being rotatably connected to the vertical support shaft near the mid-section of the vertical support shaft, and each of the distal ends of the pitch adjusting system are rotatably attached to a third bar extending between the distal ends respectively, of the double lower link arms.

The distal ends of the respective upper link arms are rotatably connected to rigid frame posts respectively at the top ends, the distal ends of the respective lower link arms are rotatably connected to the rigid frame posts near the bottom ends.

A hydraulic lift cylinder has a distal end and a near end, the near end being rotatably connected to a fourth bar extending between the near ends respectively of the upper link arms, the distal end being rotatably connected to a fifth bar extending between the distal ends, respectively, of the lower link arms.

The rigid frame is rotatably attached near the bottom ends, the rigid frame being connectable to a towing vehicle.

In addition, the combination disclosed just Supra, has hydraulic valves, hydraulic hoses, and controls for the hydraulic valves.

### BRIEF DESCRIPTION OF THE DRAWINGS

FIG. 1 is full top view of a three-point plow device of this invention.

FIG. 2 is a full side view of FIG. 1.

FIG. 3 is an enlargement of a portion of the three point plow device as shown in FIG. 1, circled area P.

FIG. 4 is full top view of a parallel arm plow device of this invention.

FIG. 5 is a full side view of FIG. 4.

FIG. 6 is a full top view of a pivoting frame parallel arm plow device of this invention.

FIG. 7 is a full side view of FIG. 6.

FIG. 8 is a full top view of a double link plow device of this invention.

FIG. 9 is a full side view of FIG. 8.

### DETAILED DESCRIPTION OF THE DRAWINGS

A pitch plow is a mechanism used for laying items underground such as flexible pipe and electric cable. The pitch plow is drawn across the ground with a towing mechanism such as a tractor or bulldozer. The material being laid into the ground is fed into a boot which is attached to a shank assembly, the details of which will be set forth infra. The material is delivered from a reservoir and travels down the boot, exiting below ground level at the elevation established by the cutting edge of the shank assembly. The grade or depth of the plow is controlled by pitching the shank/cutting edge with a pitch control mechanism.

The invention herein is the use of a dynamic weight transfer system that transfers the weight of the shank assembly to the towing vehicle thereby allowing control over the depth of the pitch plow into the ground along with pitch control, assuring accurate placement of undamaged material in the ground.

The dynamic weight transfer system exerts upward or downward force on the plow to optimize plow operation. The reaction force of the dynamic weight transfer system is applied to the pulling mechanism. The amount of force and direction can be adjusted to optimize the plowing operation as plowing conditions change.

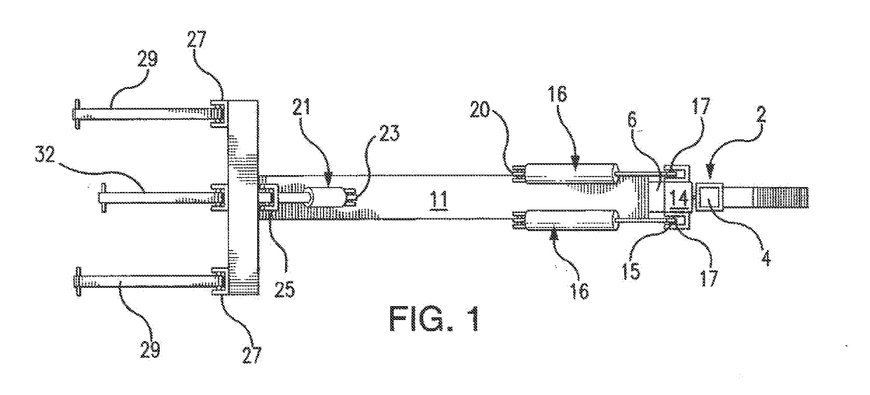

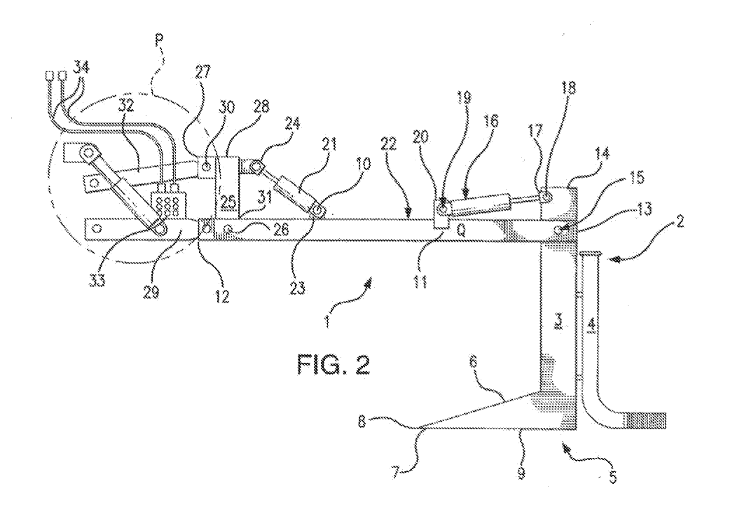

Turning now to FIGS. 1 and 2 which is a full top view of a three-point plow device 1 of this invention, and a full side view of a three-point plow device of this invention, respectively, wherein the shank assembly 2 is generally shown. The shank assembly 2 and plow are shown on the right hand side of the drawing and the hitch to the towing vehicle is shown on the left side (for orientation purposes).

The shank assembly 2 is comprised of a vertical shank 3 with a boot 4 attached to the back surface thereof. At the bottom end 5 of the vertical shank 3 there is fixedly attached, a riser plate 6. There is also a cutting edge 7 on a leading edge 8 of the riser plate 6. There is a wear shoe 9 attached to the bottom end 5 and beneath the riser plate 6 and the cutting edge 7.

The support for all of the components on this plow is provided by a frame long beam 11 which has a distal end 12 and a near end 13, wherein the beam 11 is rotatably attached to the vertical shank 3 by the near end, near the top 14 of the vertical shank 3. This attachment is provided by a steel bar (pin) 15 that is affixed to the vertical shank 3.

There is a pair of pitch adjustment hydraulic cylinders 16 that are mounted at their near ends 17 on the top 14 of the vertical shank 3 using a pin 18, and the opposite end, distal ends 19, are mounted on the top 22 of the frame long beam 11 as a point Q distant from the top 14 of the vertical shank 3. This mounting uses a pin 19 through mounting tabs 20. It is contemplated within the scope of this invention that the pair of pitch adjustment hydraulic cylinders 16 can be substituted by one large pitch adjustment hydraulic cylinder 16.

At the distal end 12 of the frame long beam 11, there is attached a lifting/lowering hydraulic cylinder 21. The lifting/lowering hydraulic cylinder 21 is attached by one end to the top 22 of the frame long beam 11 by the use of a mounting tab 23 and a pin 10, while the opposite end 24 of the lifting/lowering hydraulic cylinder 21 is rotatably attached to a standing clevis beam 25, that is rotatably attached to the frame long beam 11 by a pin 26. The standing clevis beam 25 has a bottom end 31.

The standing clevis beam 25 has a front, to which a pair of spaced-apart mounting tabs 27 are located, near the top 28 of the standing clevis beam 25. A pair of attachment arms 29 that are spaced-apart, and parallel to each other are mounted on the mounting tabs 27 using pins 30.

For purposes of this invention, the lifting/lowering hydraulic cylinders 21 can be rotatably mounted at the vertical shank 3, or also in front of the standing clevis beam 25, near the bottom 31, or both positions can have such a lifting/lowering hydraulic cylinder 21 placed thereon. This plow also has a center link arm 32.

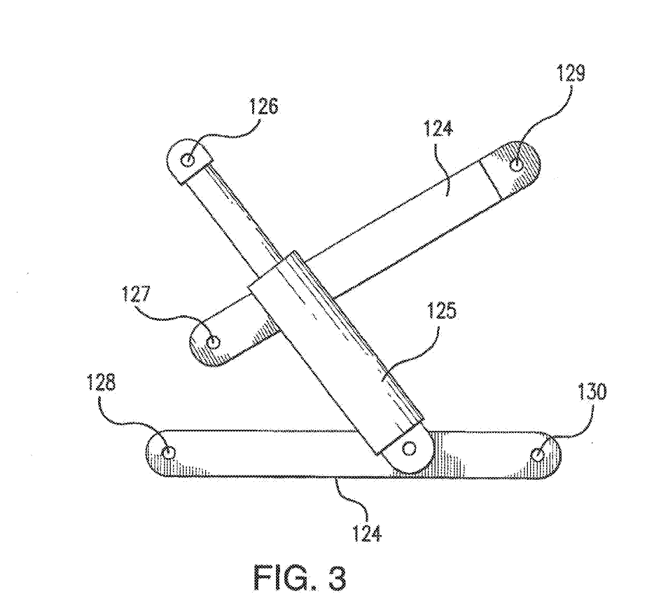

FIG. 3 is an enlargement of a typical three point hitch showing a pair of point arms 124 wherein the lower point arm is rotatably attached to a hydraulic cylinder 125. At points 126, 127, and 128, these components rotatably attach to a towing vehicle (not shown). The opposite ends of the point arms at points 129 and 130, rotatably attach to the invention set forth herein for three point hitches.

The plow is fitted with a hydraulic valve packet 33 and hydraulic transport hydraulic hoses 34 to transfer hydraulic fluid from a hydraulic oil system located en she towing vehicle to the valves and back. There is a control packet not shown, that is also located on the towing vehicle such that the operator can control the pitch of the plow and the lifting/lowering mechanism. The controls are not shown, as they are conventional equipment on most towing vehicles.

There is a “transport mode” in which the plow is elevated in order to move the plow from one place to another without plowing the ground. In the transport mode, the system works similar to a typical hydraulic lift/lowering system. When the valves are not energized, the ports connected to the lift cylinder hoses are blocked. This locks the cylinder in a set position. A directional control valve is energized to direct oil to the hydraulic cylinder. The oil extends or retracts the cylinder thus raising or lowering the tile plow. The lifting/lowering hydraulic cylinders 21 provide the power to elevate the plow for this mode. It should be noted that this also creates the force used to transfer plow weight to the towing device while the lifting/lowering system is in “installation-weight transfer mode”.

In the “installation float mode” the lift cylinder hoses are depressurized and open to the hydraulic system. This allows the lift cylinder to extend and retract while the pitch plow is controlling grade. This is how the prior art pitch plows typically function while installing tile.

In the “installation weight transfer mode” the lift cylinder can extend and retract as in the float mode. However, there is constant hydraulic pressure on the lift cylinder, on the piston side. This hydraulic pressure generates a force via the lift cylinder. This force is how the weight of the plow and down draft is transferred from the soil to the towing vehicle. The weight of the plow is now being carried by the towing vehicle. The pressure is fully adjustable up to maximum pump pressure. Typically, the operation is only at about 25% of full pressure.

In operation, the towing vehicle is connected to the plow. The towing mechanism propels the pitch plow to the location the operator wants to install the material in. The pitch plow is then lowered using the lifting/lowering mechanism, to the predetermined starting elevation for the installation. The weight transfer system is then switched on to “installation-float mode or installation weight transfer mode”. The material to be installed, i.e. flexible pipe, cable, tile, etc. is fed into the top of the boot until a predetermined amount has exited the bottom of the boot. The material that has exited the boot is then anchored by conventional means. The towing mechanism then moves forward propelling the plow forward. At this point, the lower portion of the shank assembly is displacing soil creating a temporary trench in the soil. As the temporary trench closes, it anchors the material being installed, thus causing the material to be continuously drawn through the boot as the plow moves forward.

If the weight transfer system is switched to “installation-weight transfer mode”, the lifting/lowering device is supplied with a constant pressure fluid that results in a constant force applied at the pins. The reaction force is transmitted to the towing mechanism by pins. Prior art pitch plows do not have this feature that transfers weight from the pitch plow to the pulling mechanism via constant hydraulic pressure.

The weight transfer remedies the problems and creates the benefits noted in the background section of this application. The novelty of this invention is that as plow depth changes the weight transfer force generated is constant and adjustable. These features allow the pitch plow to be optimized for varying conditions.

Grade control is obtained by pitching the shank assembly. To decrease the depth of the material being installed the pitch adjustment mechanism is extended. This rotates the shank assembly 2 about pin raising the shank toe to a higher elevation, thus raising the installed height of the material. To increase the depth of the material being installed, the pitch adjusting mechanism is retracted. This rotates the shank assembly 2 about the pin lowering the shank toe to a lower elevation thus lowering the installed height of the material. This mode of operation is applicable to all of the inventive devices disclosed herein.

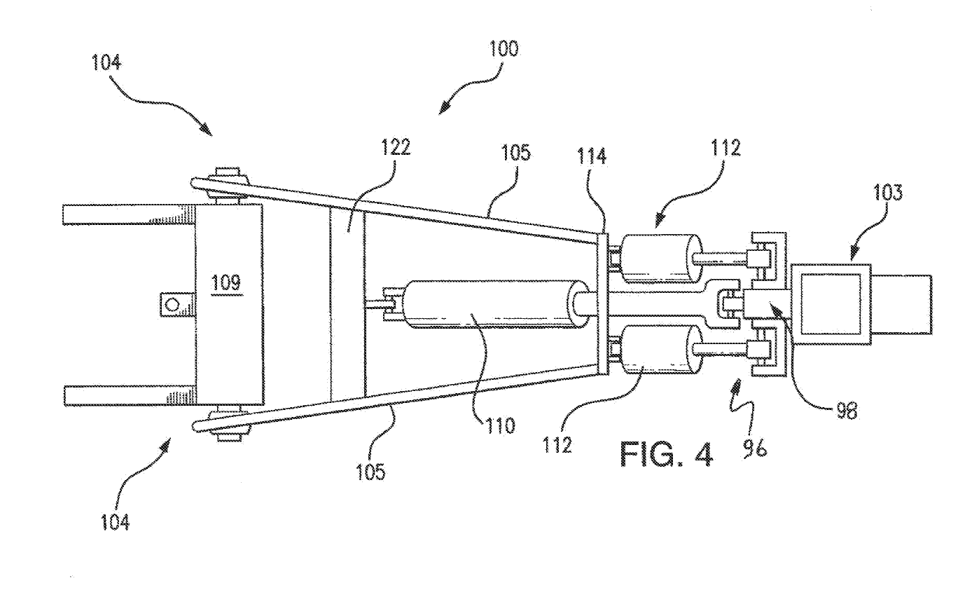

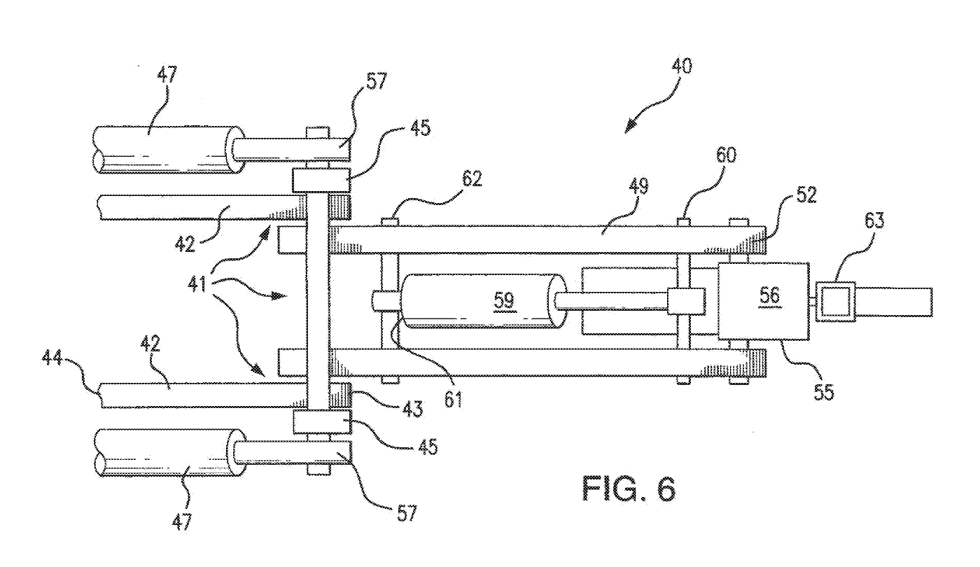

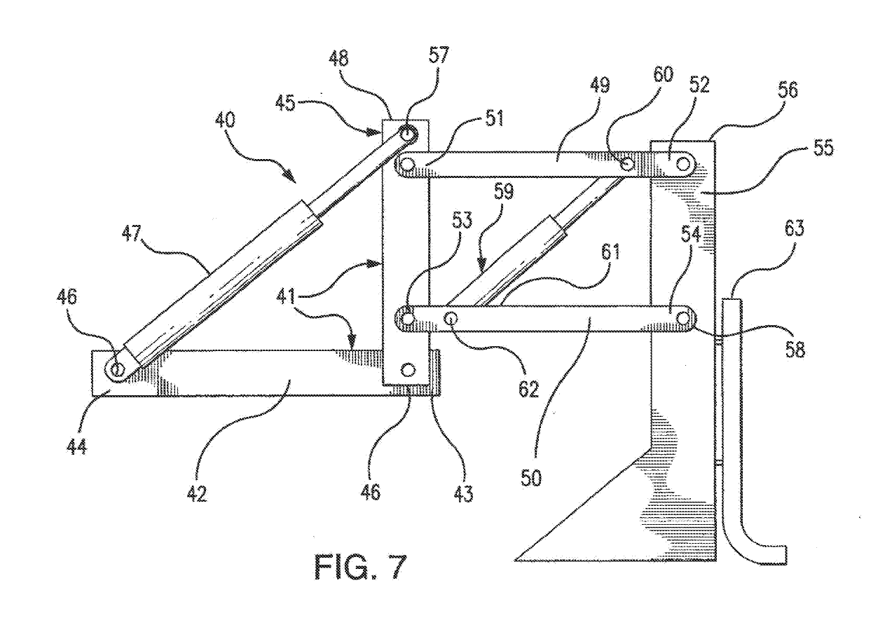

Turning now to FIGS. 6 and 7, there is shown, respectively, a top view of a pivoting frame parallel arm plow 40 and a side view of the pivoting frame parallel arm plow of FIG. 4.

This type of plow consists of a rigid frame 41 that is comprised of two, parallel connection arms 42 that are connectable to a towing vehicle. The parallel connection arms 42 each have a near end 43 and a distal end 44. The connection to the towing vehicle is made at the distal ends 44 and the near ends 43 are rotatably connected to a vertical pivoting frame 45, at or near the bottom 46 of the vertical pivoting frame 45.

There are two, parallel pivot cylinders 47 rotatably connected to the distal ends 44 of the parallel connection arms 42, each by their distal ends 46, while the near ends 57 of the parallel pivot cylinders 47 are rotatably connected to the top 48 of the vertical pivoting frame 45.

There are two, parallel upper link arms 49 and two, parallel lower link arms 50. The upper link arms 49 have distal ends 51 and near ends 52 while the lower link arms 50 have distal ends 53 and near ends 54.

The upper link arms 49 are rotatably attached near the top 48 of the vertical pivoting frame 45, by their distal ends 51 and are rotatably attached at their near ends 52 to the top 56 of a vertical shank 55. The lower link arms 50 are rotatably attached near the bottom 46 of the vertical pivoting frame 45, by their distal ends 53 and are rotatably attached at their near ends 54 to the mid-section 58 of the vertical shank 55.

There is a lift cylinder 59 rotatably attached to a bar 60 that extends between the upper link arms 49, near the near end 52 of the upper link arms 49. This is the lift cylinder that is energized for weight transfer. In addition, the opposite end 61 of the lift cylinder 59 is rotatably attached to a bar 62 that extends between the lower link arms 50.

The shank 55 is essentially equivalent to the shank disclosed Supra, as all such shanks are conventional in the industry. The shank 55 has a boot 63 attached to the rear surface thereof.

In operation, this plow operates similar to the plow operation set forth Supra.

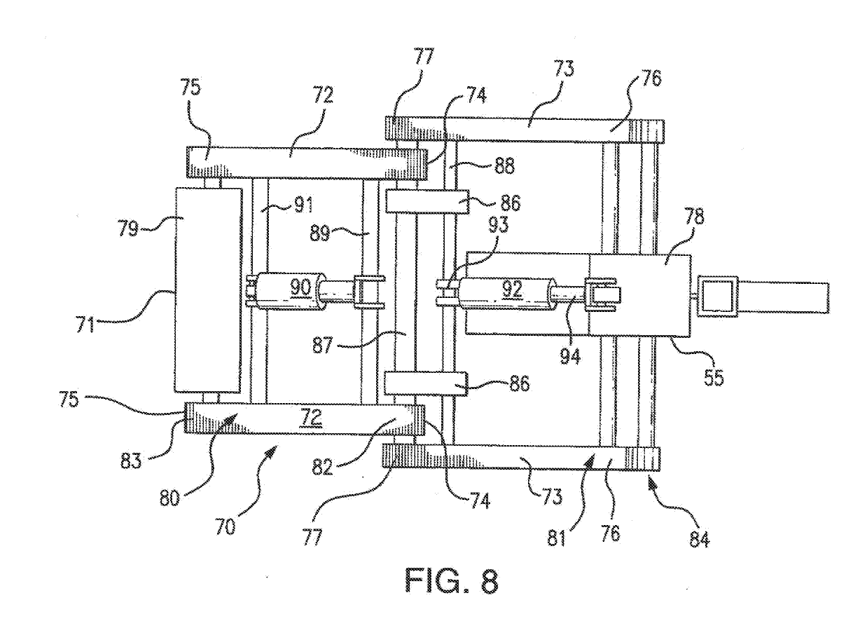

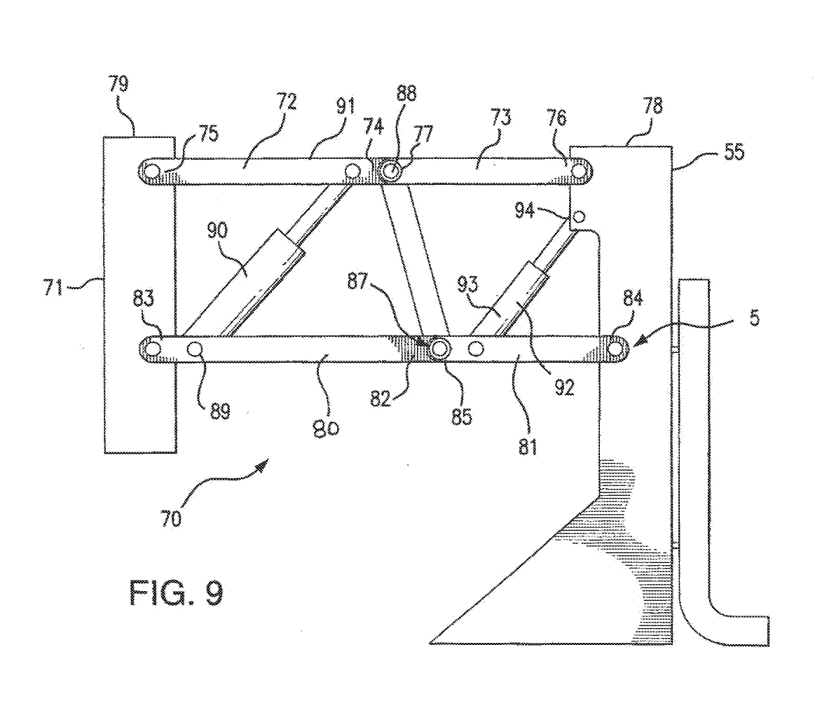

Turning now to FIGS. 8 and 9, wherein FIG. 8 is a full top view of a double link plow 70 shown in FIG. 9. FIG. 9 is a full side view of the double link plow 70 from FIG. 8. With regard to FIG. 9, there is shown a rigid frame 71 which is connectable to a towing vehicle, the connection not shown as such connections are standard in the art.

There are two, parallel upper link arms 72 and two, parallel upper double link arms 73 which are rotatably attached to each other. The two, parallel upper link arms 72 have distal ends 74 and near ends 75, and the upper double link arms 73 have distal ends 76 and near ends 77. The upper link arms 72 are rotatably attached by their distal ends 74 to the near ends 77 of the upper double link arms 73. The distal ends 76 of the upper double link arms 73 are rotatably attached near the top end 78 of shank 55. The near ends 75 of the upper link arms 72 are rotatably attached to the rigid frame 71, near the top 79 thereof.

There are two, parallel lower link arms 80 and two, parallel lower double link arms 81 which are rotatably attached to each other. The two, parallel lower link arms 80 have distal ends 82 and near ends 83, and the lower double link arms 81 have distal ends 84 and near ends 85. The lower double link arms 81 are rotatably attached at their distal ends 84 to a mid-section 95 of the shank 55. The lower link arms 80 are rotatably attached to the rigid frame 71 by their near ends 83.

The connection point of the upper link arms 72 and the upper double link arms 73 also have rotatably attached thereto, vertical arms 86. These vertical arms 86 are attached on the lower link arms/lower double link arms by a pin 87 and is rotatably attached to the upper link arm/lower double link arms by a pin 88.

There is a lift hydraulic cylinder 90 rotatably attached to a bar 89, that extends between the lower link arms 72 at the near ends 83, and the opposite end of the lift hydraulic cylinder 90 is rotatably attached to a bar 91 that extends between the upper link arms 72 at the distal ends 74.

In addition, there is a pitch hydraulic cylinder 92 that has a near end 93 and a distal end 94 wherein the pinch hydraulic cylinder 92 is rotatably attached near the top of the shank 55 by its distal and 94 and is rotatably attached by its near end 93 near the near end 85 of the lower double link arms 81.

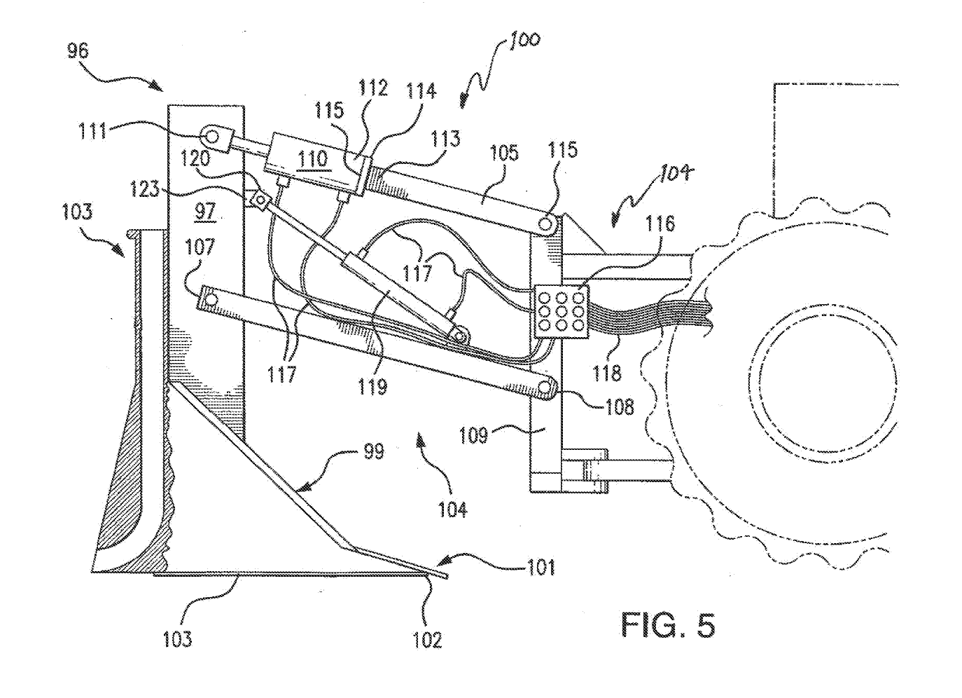

Turning now to FIGS. 4 and 5 wherein FIG. 5 is a full side view of a frame mounted parallel link plow 100 and FIG. 4 is a full top view of a frame mounted parallel link plow of FIG. 5.

With reference to FIG. 5, there is shown a full side view of the frame mounted parallel link plow 100 of this invention wherein there is shown a shank assembly 96. The shank assembly 96 is comprised of a vertical shaft 97 having a lower end 98, a riser plate 99, attached to the vertical shaft 97 of the shaft assembly 96, a cutting edge 101 on a leading edge 102 of the riser plate 99, a wear shoe 103 attached to the lower end 98 of the vertical shaft 97 and beneath the riser plate 99 and cutting edge 101, and, a boot 103 for delivering cable or flexible pipe (not shown).

There is a mounting frame generally 104, wherein the mounting frame 104 has mounted on it, two, parallel upper link arms 105 and two parallel lower link arms 106. The lower link arms 106 have a predetermined length, a distal end 107 and a near end 108. The lower link arms 106 are rotationally attached at the near end 108 to a vertical frame strut 109, and rotationally attached at the distal end 107 to the shank assembly 96.

The upper link arms 105 have a predeterminable adjustable length provided by length adjusting hydraulic cylinders 110 having distal ends 111 and near ends 112. The upper link arms 105 are rigidly attached at the near end 113 to respective butt plates 114 mounted on the near end 112 of the length adjusting hydraulic cylinders 110 and rotationally mounted on their distal ends 115 to the vertical frame strut 109.

There is a lifting/lowering mechanism 119 having a distal end 120 and a near end 121. The lifting/lowering mechanism 119 is rotationally attached at the near end 121 to a cross member 122 (see FIG. 4) extending between the parallel lower link arms 106. The distal end 120 of the lifting/lowering mechanism 119 is rotationally attached at the distal end 120 to a upper-point 123 of the shank assembly 96.

Shown in FIG. 5, are the valve pack 116, the transfer hoses 117 for the hydraulic cylinders 110, and the transfer hoses 118 to the hydraulic system (not shown) mounted within the towing vehicle. This combination is used in all of the various pitch plow inventions set forth in this specification and claims but is shown in FIG. 5 for clarity reasons.

What is claimed is:

1. A weight transfer system for pitch plows, said weight transfer system comprising:
i. a mounting system for said weight transfer system;
ii. at least one lifting/lowering mechanism attached to said pitch plow;
iii. a hydraulic valve packet that controls oil flow and pressure to each said lifting/lowering mechanism;
iv. at least two hydraulic hoses connected by one end to a hydraulic oil system and connected at the opposite ends to each said lifting/lowering mechanism to deliver the oil to and from said lifting/lowering mechanism, and,
v. a means of controlling hydraulic valves in said hydraulic valve packet.

2. In combination, a weight transfer system for pitch plows, said combination comprising:
a mounting frame connected to a towing vehicle;
said mounting frame having mounted thereon, a shank assembly, said shank assembly having connected thereto,
two, parallel upper link arms and two, parallel lower link arms, wherein said lower link arms have a predetermined length, a distal end and near end, wherein said lower link arms are rotationally attached at said near end to a vertical frame strut and rotationally attached at said distal end to said shank assembly;
said upper link arms having a predetermined adjustable length, provided by length adjusting hydraulic cylinders, a distal end and a near end, wherein said upper link arms are rigidly attached at said near end to respective said length adjusting hydraulic cylinders and rotationally attached at said distal end to said vertical frame strut;
a lifting/lowering mechanism having a distal end and a near end, said lifting/lowering mechanism being rotationally attached at said near end to a cross member extending between said parallel lower link arms, said distal end of said lifting/lowering mechanism being rotationally attached at said distal end to a mid-point of said shank assembly;
said vertical support strut being attached to said towing vehicle;
said shank assembly comprising:
a vertical shaft having a lower end;
a riser plate attached to said vertical shaft at said lower end;
a cutting edge on a leading edge of said riser plate;
a wear shoe attached to said lower end and beneath said riser plate and said cutting edge;
a boot for delivering cable or flexible pipe.

3. The combination as claimed in claim 2 wherein said combination has, in addition, hydraulic valves, hydraulic hoses, and controls for said hydraulic valves.

4. In combination, a weight transfer system for pitch plows, said weight transfer system comprising:
a mounting frame comprising:
a horizontal support beam having a near end and a distal end;
said mounting frame being rotatably attached at said near end to a vertical shank assembly having a top end and a bottom end and, near said distal end, rotatably attached to a vertical shaft having a top end;
a pitch adjusting device comprising a predetermined adjustable length and having a distal end and a near end;
said predetermined adjustable device being rotatably attached at said near end to said shank assembly near said top end of said shank assembly, said distal end of said predetermined adjustable device being rotatably attached to said horizontal support beam near said near end;
a lifting/lowering mechanism having a distal end and a near end, said lifting/lowering mechanism being rotationally attached by said near end near said distal end of said horizontal beam, said distal end of said lifting/lowering mechanism being rotationally attached at said distal end to said vertical shaft, said vertical shaft being attached to said distal end of said horizontal beam;
said distal end of said horizontal support beam and said top end of said vertical shaft being connectable to a conventional three-point hitch;
said shank assembly comprised of:
a vertical support shaft having a lower end;
a riser plate attached to said vertical support shaft;
a cutting edge on a leading edge of said riser plate;
a wear shoe attached to said lower end and beneath said riser plate and said cutting edge;
a boot for delivering cable or flexible pipe.

5. The combination as claimed in claim 4 wherein said combination has, in addition, hydraulic valves, hydraulic hoses, and controls for said hydraulic valves.

6. In combination weight transfer system for pitch plows, said weight transfer system comprising:
a mounting frame, said mounting frame comprising:
two parallel, spaced-apart upper link arms, each said upper link arm having a distal end and a near end;
two parallel, spaced-apart lower link arms, each said lower link arm having a distal end and a near end;
a pitch adjusting system;
a pivoting frame having a bottom end;
a shank assembly, said shank assembly comprising:
a vertical support shank, said vertical support shank having a top end and a bottom end, said bottom end having fixedly attached thereto, a riser plate, said riser plate having a cutting edge on a leading edge of said riser plate; a wear shoe attached to said vertical support shank bottom end and beneath said riser plate and said cutting edge, and attached to said vertical support shank, at said back thereof, a boot for delivering cable or flexible pipe;
said distal ends of said upper link arms being rotatably attached near said top of said vertical support shank, and said near ends of said upper link arms being rotatably attached, respectively, to a vertical post of said pivoting frame near a top thereof;
said distal ends of said lower link arms being rotatably attached near said mid-section of said vertical support shank and said near ends of said lower link arms being rotatably attached to said vertical post of said pivoting frame near said bottom thereof;
a hydraulic lift cylinder being rotatably attached to a first bar, said first bar being supported between said upper link arms near said distal ends thereof;
said opposite ends of said hydraulic lift cylinder being rotatably attached to a second bar, said second bar being supported between said lower link arms, near said near ends thereof;
said pivot frame being rotatably attached near said bottom thereof, to a conventional pivoting frame arm plow;
two parallel, spaced-apart pivoting hydraulic cylinders being rotatably attached by one end near said top of said, respective, vertical posts of said pivoting frame;
said opposite ends of said pivoting hydraulic cylinders being rotatably attached near distal ends to a rigid frame having near ends;
each said near end of said rigid frame being rotatably attached near said bottom of each said pivoting frame vertical post, said opposite ends of said rigid frame being connectable to a towing vehicle.

7. The combination as claimed in claim 6 wherein said combination has, in addition, hydraulic valves, hydraulic hoses, and controls for said hydraulic valves.

8. In combination, weight transfer system for pitch plows, said weight transfer system comprising:
a mounting frame said mounting frame comprising:
a forward rigid frame assembly having a top end and a bottom end;
two, parallel, spaced-apart upper link arms each having distal ends and near ends;
two, parallel, spaced-apart lower link arms each having distal ends and near ends;
two, parallel, spaced-apart double upper link arms, each having distal ends and near ends;
two, parallel, spaced-apart double lower link arms, each having distal ends and near ends;
said distal ends of each respective double upper link arms and said near ends of each respective upper link arms being rotatably commonly connected to each other by a first bar extending between said respective upper link arms and double upper link arms;
said distal ends of each respective double lower link arms and said near ends of said each respective lower link arms are rotatably commonly connected to each other by a second bar extending between said respective lower link arms and lower double link arms;
said upper double link arms being rotatably connected to said near ends to said tops of said vertical support shaft, said lower double link arms being rotatably connected at said near end to said mid-section of said vertical support shaft;
said pitch adjusting system having a near end and a distal end, said near end being rotatably connected to said vertical support shaft near said mid-section of said vertical support shaft, each said distal end of said pitch adjusting systems being rotatably attached to a third bar extending between said distal ends respectively, of said double lower link arms;
said distal ends of said respective upper link arms being rotatably connected to rigid frame posts respectively at said top ends, said distal ends of said respective lower link arms being rotatably connected to said rigid frame posts near said bottom ends;
a hydraulic lift cylinder having a distal end and a near end, said near and being rotatably connected to a fourth bar extending between said near ends respectively of said upper link arms, said distal end being rotatably connected to a fifth bar extending between said distal ends, respectively, of said lower link arms;
said rigid frame being rotatably attached near said bottom ends, said rigid frame being connectable to a towing vehicle.

9. Said combination as claimed in claim 8 wherein said combination has, in addition, hydraulic valves, hydraulic hoses, and controls for said hydraulic valves.
